(19) United States
(12) Patent Application Publication
(10) Pub. No.: US 2004/0196483 A1
(43) Pub. Date: Oct. 7, 2004

(54) Line based parallel rendering

(76) Inventor: Dana A. Jacobsen, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/409,547

(22) Filed: Apr. 7, 2003

(51) Int. Cl. G06F 15/00; H04N 1/04

(52) U.S. Cl. 358/1.13; 358/1.15; 358/474

(57) ABSTRACT

Print data is rendered by separating page strips into scan lines and distributing the scan lines among a plurality of processors for parallel rendering.

### TECHNICAL FIELD

The present disclosure generally relates to printing, and more particularly, to processing print data by rendering individual scan lines on a plurality of processors running in parallel.

### BACKGROUND

A typical printing environment includes a source or host device, such as a computer, that provides image or object information in the form of print data to a printing device. Exemplary printing devices may include, for example, a laser printer, an ink jet printer, a thermal printer, a facsimile device, a copier and so on. Such devices generally require increasing amounts of memory to process the print data from source devices. However, because memory space on most printing devices is somewhat limited, various methods have been devised for saving memory while processing print data.

A host computer typically provides a printing device with pages that are formatted in a page description language (PDL) such as Hewlett Packard's Printer Control Language (PCL) or Adobe's Postscript. The printing device parses and renders the PDL to form an image of a page that is suitable for the type of print engine being used. During the formatting of a page, a description of the page (i.e., in a PDL) received from a host is converted into a series of simple commands or “objects” that describe what will be printed. The objects are parsed and sorted according to their vertical position on the page. The page is logically divided into sections called strips. The strips are then individually rendered (i.e. the described objects in the strips are rendered) into a raster image that is passed to the print engine for printing. While horizontal strips are discussed here, vertical strips or other tilings of the page can also be used.

Dividing a page into a plurality of strips enables lesser amounts of RAM to be used for the print image than would otherwise be required if all the objects on a page were to be rendered at the same time and stored in RAM as bit map data (i.e., raster data). This procedure therefore provides a more economical way to render object data from PDL drawing commands. Conventional printers usually divide a page into about 50 to about 100 page strips, each of which is defined by an associated display list. The display list is directed only to those objects that fall within the respective strip. The simple objects in a strip are decomposed from more complex PDL objects. The display list includes commands or operational codes (opcodes) generated from parsing the PDL drawing commands. Display list commands identify objects and provide information necessary about the objects, such as their size and color. For example, a rectangle object might be identified as a “rectangle” followed by X and Y coordinates, a width measurement, and a height measurement. Display lists having such commands parsed from PDL commands can be relatively compact in size. Thus, the amount of printer memory required to process the print data is reduced.

Once a display list has been generated for a page strip, a rendering process renders the page strip as raster data directly to a print engine or into memory for temporary buffering or compression. For printers that render the strips into memory, the amount of memory required is substantially reduced when compared to rendering a whole page and storing it in RAM as raster data. For example, if there are 50 strips in a page, then a printer needs rendering storage for only about 1/50 the amount of memory than that needed to render and store a whole page.

Dividing a page into strips in order to render object data from PDL drawing commands lends itself particularly well to parallel processing. In general, parallel processing can improve the performance of many types of systems through the distribution of work among a plurality of processors. Because page strips are independent from one another, each page strip can be processed (i.e., rendered) by a different processor. Accordingly, certain conventional printers take advantage of parallel processing by rendering multiple page strips simultaneously on one or more processors.

Unfortunately, there are certain disadvantages to rendering multiple page strips simultaneously in a parallel processing printing environment. The main disadvantage is that rendering multiple page strips simultaneously requires the availability of significantly more memory on a printer. This is because each strip typically requires from between about 1 MB to about 4 MB of memory. Depending on the number of strips being rendered simultaneously, the necessary memory can quickly add up to an amount that it is not economically reasonable for many printers. Other disadvantages in rendering multiple page strips simultaneously in a parallel processing printing environment can include implementation problems in some printing systems and a need to make fundamental changes to certain system components.

Accordingly, the need exists for a better way to apply parallel processing to rendering print data that avoids various disadvantages encountered in current printers.

### SUMMARY

Print data is rendered by separating page strips into scan lines and distributing the scan lines among a plurality of processors for parallel rendering.

### BRIEF DESCRIPTION OF THE DRAWINGS

The same reference numbers are used throughout the drawings to reference like components and features.

FIG. 1 illustrates a system environment that is suitable for line based parallel rendering.

FIG. 2 is a block diagram illustrating in greater detail, a particular embodiment of a computer input device and a printer as might be implemented in the system environment of FIG. 1.

FIG. 3 illustrates a page divided into page strips through a technique applied in many conventional printing devices.

FIG. 4 illustrates a page strip such as those shown in FIG. 3 having a plurality of scan lines.

FIG. 5 illustrates a typical functional arrangement of various components of the embodiment shown in FIG. 2.

FIG. 6 is a block diagram illustrating in greater detail, an alternate embodiment of a computer input device and a printer as might be implemented in the system environment of FIG. 1.

FIG. 7 is a block diagram illustrating in greater detail, another alternate embodiment of a computer input device and a printer as might be implemented in the system environment of FIG. 1.

FIG. 8 is a flow diagram illustrating an example method of line based parallel rendering.

FIG. 9 is a flow diagram illustrating another example method of line based parallel rendering.

FIG. 10 is a flow diagram illustrating another example method of line based parallel rendering.

FIG. 11 is a flow diagram illustrating another example method of line based parallel rendering.

### DETAILED DESCRIPTION

The current disclosure relates to rendering print data based on individual scan lines processed on a plurality of processors (i.e., two or more processors) running in parallel. Benefits of the disclosed system and methods include parallel rendering on a granular level that promotes the efficient utilization of available parallel processing resources. Further benefits include a reduction in the amount of memory needed to accommodate parallel rendering of print data when compared to previous parallel rendering methods.

Exemplary System Environment For Line Based Parallel Rendering of Print Data

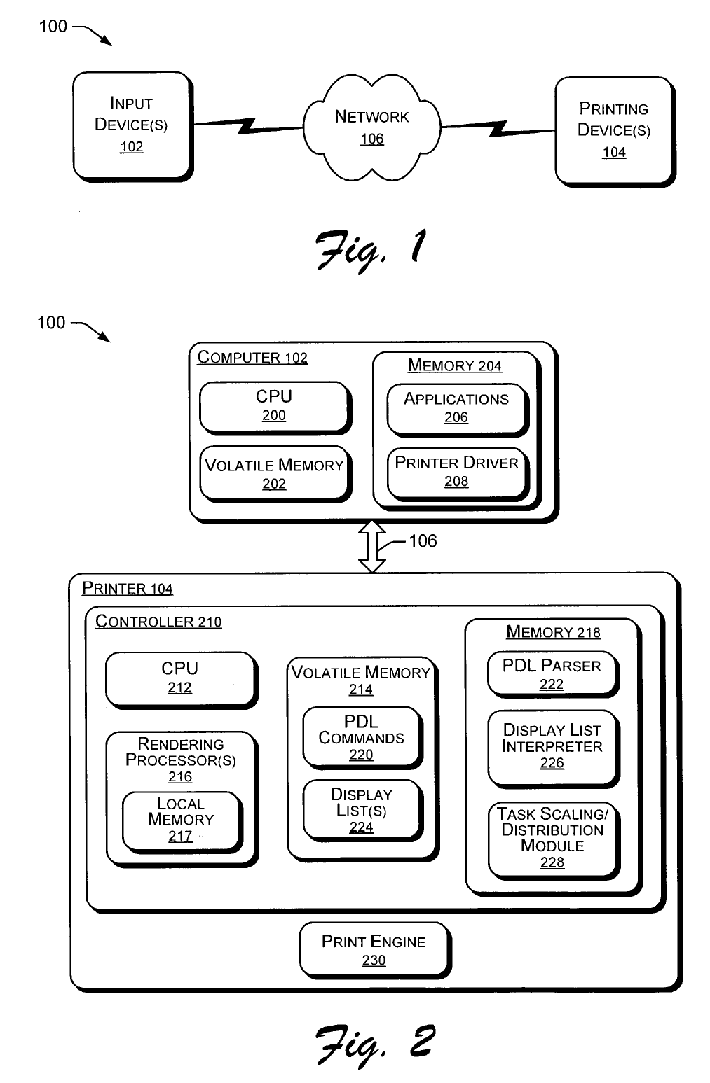

FIG. 1 illustrates an example of a system environment 100 suitable for line based parallel rendering of print data. The exemplary system environment 100 of FIG. 1 includes input device(s) 102 and printing device(s) 104 operatively coupled through a network connection 106. The network connection 106 can include both local and remote connections depending on the particular system configuration. Thus, network connection 106 may include, for example, a printer cable, a LAN (local area network), a WAN (wide area network), an intranet, the Internet, or any other suitable communication link. Network connection 106 might also include a wireless communications link such as an IR (infrared) or RF (radio frequency) link.

Input device(s) 102 can be implemented as a variety of general purpose computing devices including, for example, a personal computer (PC), a laptop computer, a handheld PDA (e.g., Palmtop, PalmPilot), a Macintosh, a workstation computer, and other devices configured to communicate with printing device(s) 104. An input device 102 typically provides a user with the ability to manipulate or otherwise prepare in electronic form, an image or document that can be rendered as an image to be printed or otherwise formed in hardcopy on a print medium by a printing device 104 after transmission over network 106.

In general, an input device 102 outputs formatted print data to a printing device 104 which converts the data and outputs it onto an appropriate recording media, such as paper or transparencies. Print data from input device 102 is generally formatted by a printer driver into a PDL (page description language) format suitable for printing device 104, such as Hewlett Packard's PCL (Printer Control Language) or Adobe's Postscript, prior to being sent to printing device 104.

Printing device(s) 104 can be implemented as various types of printers capable of rendering PDL data in printed form on a print medium, such as printing pixels on paper. Therefore, printing device(s) 104 can include devices such as laser-based printers, ink-based printers, dot matrix printers, dry medium printers, plotters and the like. In addition, printing device(s) 104 might also include various multi-function peripheral (MFP) devices that combine a printing function with other functions such as facsimile transmission, scanning, copying and the like.

Exemplary System Embodiments For Line Based Parallel Rendering of Print Data

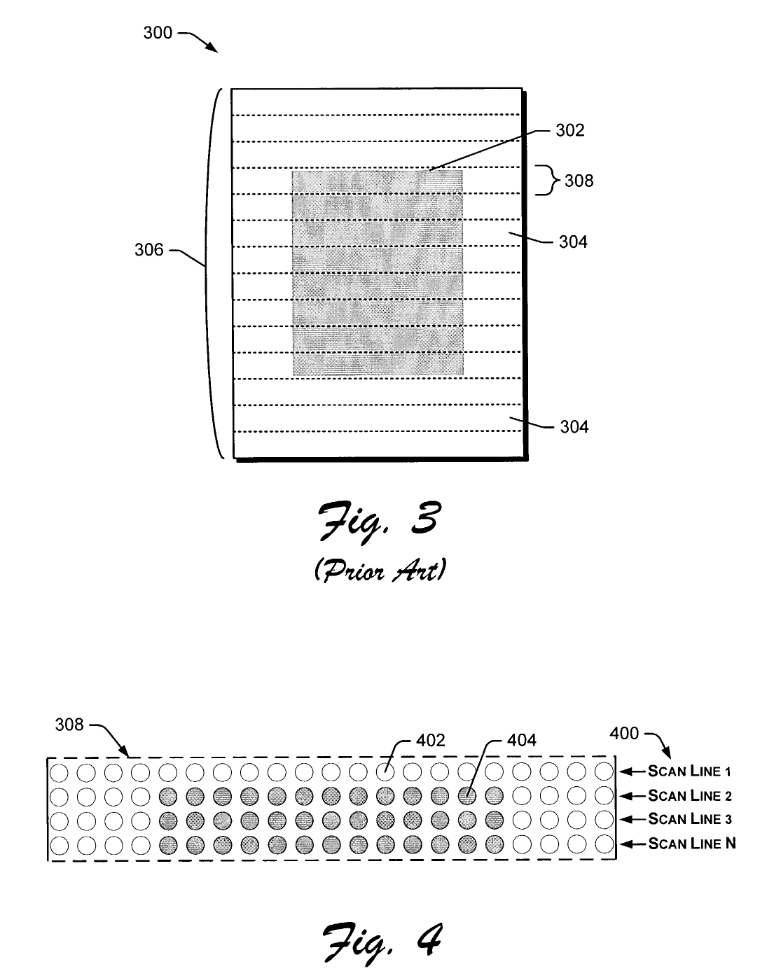

FIG. 2 is a block diagram illustrating an exemplary embodiment of an input device 102 and a printing device 104 as might be implemented in the system environment 100 of FIG. 1. Input device 102 is embodied as computer 102. Printing device 104 is embodied as printer 104.

Computer 102 typically includes a processor 200, a volatile memory 202 (i.e., RAM), and a nonvolatile memory 204 (e.g., ROM, hard disk, floppy disk, CD-ROM, etc.). Nonvolatile memory 204 generally provides storage of computer/processor-readable instructions, data structures, program modules and other data for computer 102. Computer 102 may implement various application programs 206 stored in memory 204 and executable on processor 200 to create or otherwise form a document or image (e.g., text and graphics) on a computer screen that is transferable over network connection 106 to printer 104 for creating a hard copy of the document/image. Such applications 206 might include software programs implementing, for example, word processors, spread sheets, browsers, multimedia players, illustrators, computer-aided design tools and the like.

Computer 102 also typically implements one or more software-based device drivers such as printer driver 208 that are stored in nonvolatile memory 204 and executable on processor 200. Device drivers might also be implemented on the specific devices they are “driving”, such as printer 104. In general, printer driver 208 receives print data from an application program 206 in an application format and translates it into a printer-friendly format (i.e., a PDL) such as Hewlett Packard's PCL or Adobe's Postscript, or another appropriate format. The PDL formatted print data is then output to printer 104 where it is rendered and output in hardcopy form onto a print medium such as paper or transparencies. The rendering of PDL formatted print data is discussed in further detail below. In addition it is noted that in certain system configurations, such rendering might also take place on an input device such as computer 102.

Printer 104 includes controller 210 that, in general, processes data from computer 102 to control the output of printer 104 through print engine 230. In the embodiment of FIG. 2, controller 210 includes a main data processing unit or CPU 212, a volatile memory 214 (i.e., RAM), one or more parallel rendering processors 216 and a nonvolatile memory 218. In the FIG. 2 embodiment, there is a general distinction made between the main CPU 212 and the parallel rendering processor(s) 216 on printer 104. The main CPU 212 is generally tasked with executing normal printer functions, including the execution of modules 220, 222, 226, and 228. Rendering processor(s) 216 are specifically tasked with rendering individual scan lines as further discussed below. Rendering processor(s) 216 may be one or more general-purpose processors, limited-purpose processors, or specialized rendering processors. They may use only shared memory (i.e., memory 214) or they may have a local memory 217.

Volatile memory 214 provides temporary storage of data in current use by processor 212, such as computer/processor-readable instructions, data structures, and program modules. Accordingly, volatile memory 214 includes PDL commands 220 received from computer 102 and display lists 224. Nonvolatile memory 218 can include various computer storage media such as ROM, flash memory, a hard disk, a removable floppy disk, a removable optical disk and the like. Nonvolatile memory 218 generally provides storage of computer/processor-readable instructions, data structures, program modules and other data for printer 104. Thus, nonvolatile memory 218 includes a PDL parser 222, a display list interpreter 226, and a task scaling and distribution module 228.

PDL parser 222 is generally configured to receive PDL drawing commands 220 and parse them into display list commands, or objects that define a page of print data as a plurality of strips or bands. A page is typically divided, for example, into about 50 to about 100 page strips. Each page strip has an associated display list 224 with operational codes (opcodes) that define print objects that fall within the respective strip. Thus, opcodes in each display list 224 identify objects and provide information necessary about those objects, such as their size and color.

The display list interpreter 226 is generally configured to interpret display list objects and provide rendering commands (or scan line commands) to rendering processors 216 that define how individual scan lines are to be rendered. The task scaling and distribution module 228 generally determines how scan line commands representing individual scan lines are to be distributed among available rendering processors 216. The display list interpreter 226 and task scaling and distribution module 228 will be discussed in more detail below.

First, however, an exemplary page strip generating technique as applied in many conventional printing devices, and as appropriate for use in the embodiments of the present disclosure, is presented now by way of instruction. Accordingly, reference is made to the illustrative diagram in FIG. 3. Here, a page strip generating technique as described in the Background section above, for example, is employed to divide a page 300 that includes a dark object area 302 and a light object area 304 into a plurality of page strips 306. As shown, the strips 306 extend horizontally across the width of the page to be printed. It is noted that the horizontal construction of strips 306 in FIG. 3 is intended merely as an example, and not as a limitation. That is, page strips may also extend vertically. Furthermore, various other tilings of the page 300 are also contemplated by this disclosure.

Some of the strips 306 include only light object area 304, while other strips 306, such as strip 308, include both light object area 304 and dark object area 302. This illustrated strip generating technique corresponds to the generation of display lists discussed above, wherein PDL drawing commands 220 are divided or parsed along the boundaries defined by the strips 306. Consequently, each strip 306 will have a specific display list 224 that can be rendered and printed to produce the appropriate light/dark objects on a printed page. As mentioned earlier, parallel rendering of such strips 306, while beneficial, has various disadvantages.

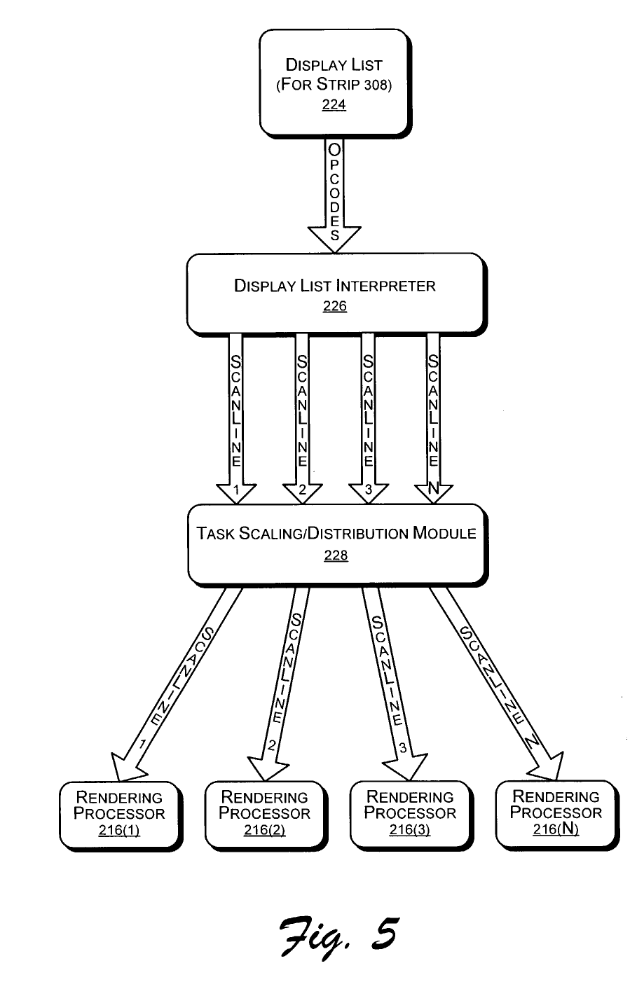

Accordingly, methods and devices are disclosed that provide improved parallel rendering of print data while alleviating such disadvantages. The disclosed parallel rendering based on scan lines promotes an efficient use of available parallel processing resources while reducing the amount of memory needed to accommodate prior parallel rendering based on page strips. Thus, in accordance with certain exemplary embodiments of the present disclosure, attention is now drawn to FIGS. 2 and 4, which illustrate parallel rendering of print data on the basis of individual scan lines.

As briefly mentioned above, the display list interpreter 226 of FIG. 2 is generally configured to interpret display list opcodes as rendering commands (scan line commands) that define how individual scan lines are to be rendered, while the task scaling and distribution module 228 generally determines how scan line commands for individual scan lines are to be distributed among available rendering processors 216. Scan line commands generated from opcodes control the drawing of individual scan lines and instruct rendering processors 216 how to render the pixels in each scan line.

FIG. 4 shows a page strip 306 such as strip 308 from FIG. 3, and is intended to illustrate how such a strip comprises a plurality of scan lines 400 (e.g., Scan line 1, Scan line 2, Scan line 3, . . . Scan line N). FIG. 4 is provided for purposes of illustration only, however, and is not intended to indicate the actual number of pixels in a scan line 400, the actual number of scan lines 400 in a page strip 306, or the size of the pixel data that might be present in an actual page strip 306. For example, a page strip 306 in most printers typically has from about 100 to about 200 scan lines, while each scan line may have 300, 600, 1200, or more pixels per inch of scan line depending on the resolution of the printer. Each scan line is a 1 pixel high segment of a page strip 306. Page strip 308 of FIG. 4 illustrates light pixels 402 representing light object area (e.g., area 304 of FIG. 3) and dark pixels 404 representing dark object area (e.g., area 302 of FIG. 3).

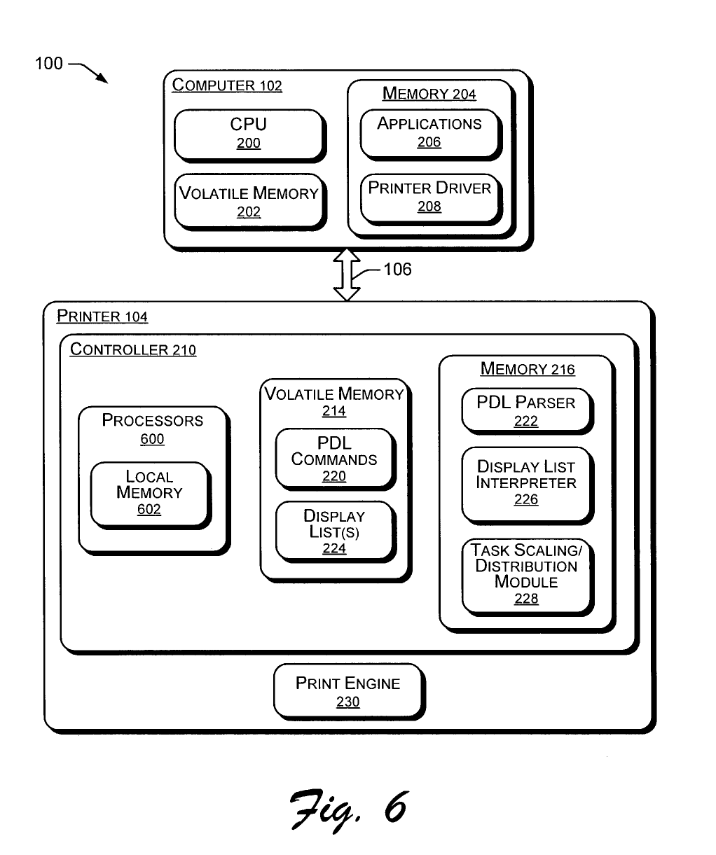

FIG. 5 illustrates functional aspects of various components within the embodiment of FIG. 2 that serve to separate a page strip into individual scan lines and distribute those scan lines as scan line commands (i.e., rendering commands) to be rendered among the various rendering processors 216 (e.g., 216(1), 216(2), 216(3), . . . 216(N)) running in parallel. Thus, opcodes stored in a display list 224 representing page strip 308 are interpreted by display list interpreter 226 as scan line commands that represent individual scan lines 400 (i.e., Scan line 1, Scan line 2, Scan line 3, . . . Scan line N). In a non-parallel processing system scan lines 400 would reside in memory 214, while in a parallel system having a plurality of parallel rendering processors 216, they may reside in memory 214 or in local memory 217.

Task scaling and distribution module 228 determines how scan line commands representing individual scan lines 400 are to be distributed among available parallel rendering processors 216. If there are enough parallel rendering processors 216 available, each scan line 400 from a page strip 306 (e.g., Scan lines 1, 2, 3, . . . N, from strip 308) is distributed as scan line commands to a distinct processor 216 for rendering into pixel/raster data. However, task scaling and distribution module 228 also scales the distribution of individual scan lines 400 among available rendering processors 216 when a page strip 306 has more scan lines 400 than there are available rendering processors 216. Thus, each rendering processor may receive a plurality of scan lines 400 as tasks to be processed into raster data.

In the current embodiment of FIG. 2, task scaling and distribution module 228 typically processes and distributes scan line commands representing scan lines 400 into a local memory 217 on each of the rendering processors 216 as processing capacity becomes available on the rendering processors 216. However, task scaling and distribution module 228 might also queue scan line commands into a shared memory such as memory 218 before distributing them to rendering processors 216 so that the rendering processors 216 themselves can retrieve the scan line commands as processing capacity becomes available. Whether scan line commands are queued into a shared memory first or directly distributed among rendering processors 216 depends in part on the availability of a local memory 217 on rendering processors 216. In certain configurations, rendering processors 216 may not have a local memory 217, in which case the scan line commands (representing scan lines 400) would be queued into a shared memory prior to being distributed to rendering processors 216.

In either case, a plurality of rendering processors 216 simultaneously process (i.e., render) numerous scan lines 400 (i.e., tasks) into pixel/raster data. The rendered data ultimately drives a print engine 230 to create an image on a print medium. The rendered data may first be compressed, however, and temporarily stored or buffered prior to being decompressed and sent to a print engine 230 for printing. Alternatively, the rendered data might be provided immediately to the print engine 230 for printing with minimal or no buffering.

FIG. 6 illustrates an alternate embodiment configured primarily the same as the embodiment of FIG. 2. However, in the FIG. 6 embodiment there is no distinction made between a main processor and various rendering processors. Rather, processors 600 on controller 210 are general purpose processors configured to perform a variety of tasks, including, for example, executing normal printer functions, executing modules 220, 222, 226, and 228, and rendering individual scan lines. Thus, the execution of tasks such as parsing PDL commands 220 might be performed by any one of a number of general purpose processors 600 rather than being specifically assigned to a main processor each time. Likewise, each general purpose processor 600 can serve as a rendering processor to render scan line commands representing scan lines 400 into pixel/raster data as generally described above with respect to the FIG. 2 embodiment.

Therefore, the general description of the parallel rendering on a scan line basis as described above with respect to FIGS. 3-5 applies similarly to the FIG. 6 embodiment. For example, referring to FIGS. 4 and 5, display list interpreter 226 interprets opcodes stored in a display list 224 as scan line commands that represent individual scan lines 400 (i.e., Scan line 1, Scan line 2, Scan line 3, . . . Scan line N) as described above. However, the display list interpreter 226 may be executing on any one of the general purpose processors 600. In addition, task scaling and distribution module 228 may be executing on any one of the general purpose processors 600 in determining how to distribute scan line commands for rendering individual scan lines 400. However, scan line commands for individual scan lines 400 may be distributed to any of the general purpose processors 600 for parallel rendering. Thus, if there are enough general purpose processors 600 available, commands for each scan line 400 from a page strip 306 (e.g., Scan lines 1, 2, 3, . . . N, from strip 308) are distributed to a distinct general purpose processor 600 for rendering into pixel/raster data. However, depending on the number of general purpose processors 600, each processor 600 may receive scan line commands for a plurality of scan lines 400 to be processed into raster data.

In a manner similar to that discussed above regarding the FIG. 2 embodiment, task scaling and distribution module 228 typically processes and distributes scan line commands into a local memory 602 on each general purpose processor 600 as processing capacity becomes available on each processor 600. However, task scaling and distribution module 228 might also queue scan line commands (representing scan lines 400) into a shared memory such as memory 216 before distributing them to processors 600, so that the processors 600 themselves can retrieve the scan line commands as processing capacity becomes available.

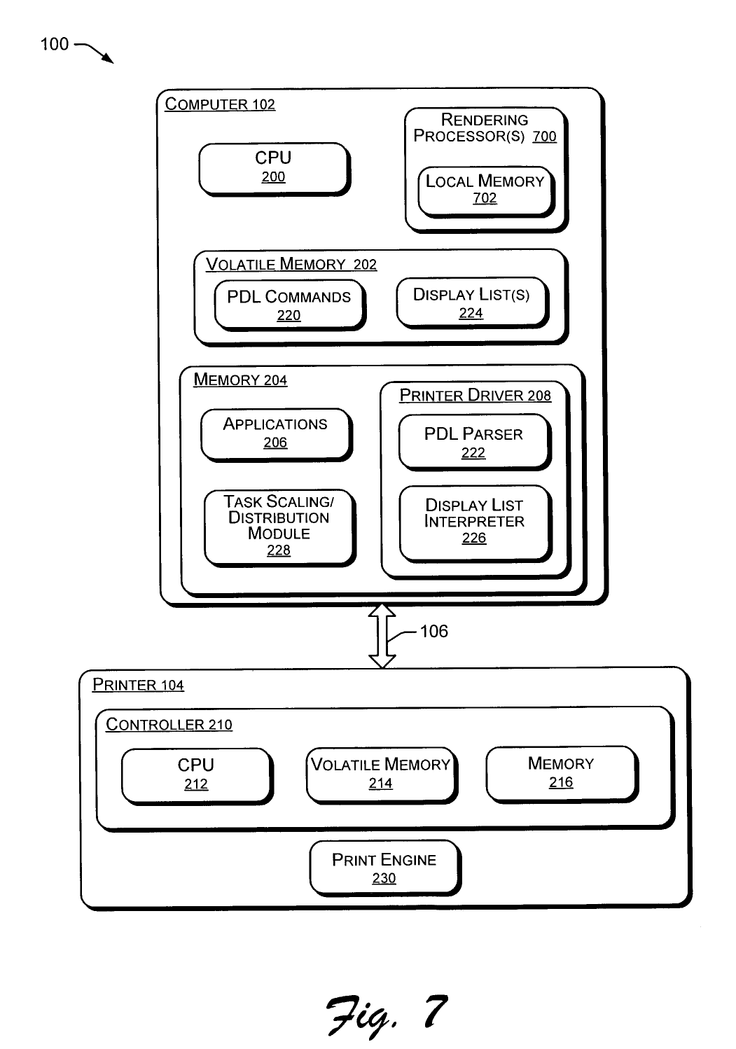

FIG. 7 illustrates another alternate embodiment of an input device/computer 102 and a printing device 104 as might be implemented in the system environment 100 of FIG. 1. Computer 102 and printer 104 are configured in a manner similar to that described above with respect to the FIG. 2 embodiment, except that the parallel rendering of scan lines is performed by computer 102 rather than by printer 104. Accordingly, computer 102 includes one or more rendering processors 700 while its memory 202 includes PDL commands 220 and display lists 224. Non-volatile memory 204 includes a PDL parser 222, a display list interpreter 226, and a task scaling and distribution module 228. PDL parser 222 and display list interpreter 226 are executable modules that might normally be associated with printer driver 208 on computer 102, so they are illustrated as being a part of printer driver 208. However, they might also be separate modules stored in memory 204. As discussed above, task scaling and distribution module 228 generally facilitates the parallel processing function of distributing scan line commands representing individual scan lines among available rendering processors 700.

FIGS. 4 and 5 generally apply to the embodiment of FIG. 7 as they are discussed above with respect to the FIG. 2 embodiment. Thus, on computer 102 of FIG. 7, display list interpreter 226 interprets opcodes stored in a display list 224 into scan line commands that represent individual scan lines 400 (i.e., Scan line 1, Scan line 2, Scan line 3, . . . Scan line N). Executable modules such as the PDL parser 222, the display list interpreter 226, and the task scaling and distribution module 228 execute on processor 200. Scan line commands representing individual scan lines 400 may be distributed to any of the rendering processors 700 for parallel rendering. Thus, if there are enough rendering processors 700 available, commands for each scan line 400 from a page strip 306 (e.g., Scan lines 1, 2, 3, . . . N, from strip 308) are distributed to a distinct rendering processor 700 for rendering into pixel/raster data. However, depending on the number of rendering processors 700, each processor 700 may receive scan line commands for a plurality of scan lines 400 to be processed into raster data.

In a manner similar to the FIG. 2 embodiment discussed above, the task scaling and distribution module 228 in the FIG. 7 embodiment typically processes and distributes scan line commands into a local memory 702 on each of the rendering processors 700 as processing capacity becomes available on the rendering processors 700. However, task scaling and distribution module 228 might also queue scan line commands (representing scan lines 400) into a shared memory such as memory 202 before distributing them to rendering processors 700 so that the rendering processors 700 themselves can retrieve the scan line commands as processing capacity becomes available. As scan line commands are rendered, they are sent to printer 104 for output onto a print medium through print engine 230.

Exemplary Methods For Line Based Parallel Rendering of Print Data

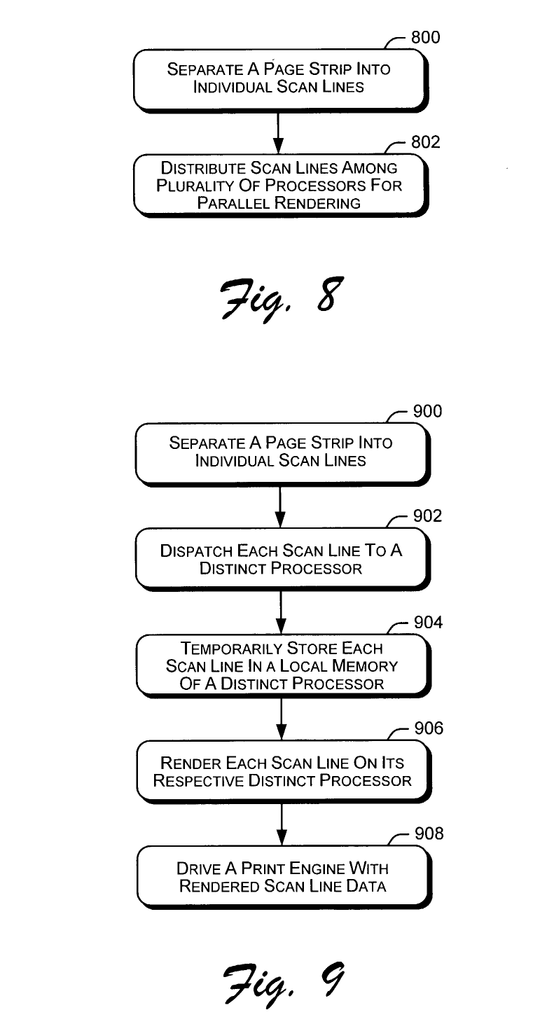

Example methods for providing line based parallel rendering of print data will now be described with primary reference to the flow diagrams of FIGS. 8-11. The methods apply generally to the exemplary embodiments discussed above with respect to FIGS. 1-7. The elements of the described methods may be performed by any appropriate means, such as by the execution of processor-readable instructions defined on processor-readable media, such as a disk, a ROM or other such memory device.

Referring to the method illustrated in FIG. 8, at block 800, a page strip is separated into individual scan lines. A page strip represents a portion of a printable page that is defined by display list commands or objects that have been parsed from PDL drawing commands. The display list commands within each page strip define objects that fall within the respective strip. At block 802 of FIG. 8, individual scan lines are distributed among a plurality of processors for parallel rendering. Depending on the number of available rendering processors, the distribution may be one or more scan lines from a page strip being dispatched to each of a plurality of processors.

Referring now to the method illustrated in FIG. 9, at block 900, a page strip is separated into individual scan lines. At block 902, each scan line is dispatched to a distinct processor. The scan lines are temporarily stored in a local memory present on each of the processors as indicated by block 904. It is also possible that each scan line is temporarily stored in a shared memory that is accessible by each processor, and then retrieved from the shared memory by a distinct processor. At block 906, each scan line is rendered by its respective distinct processor. At block 908, rendered scan line data (i.e., pixel/raster data) drives a print engine to produce an object image according to the data.

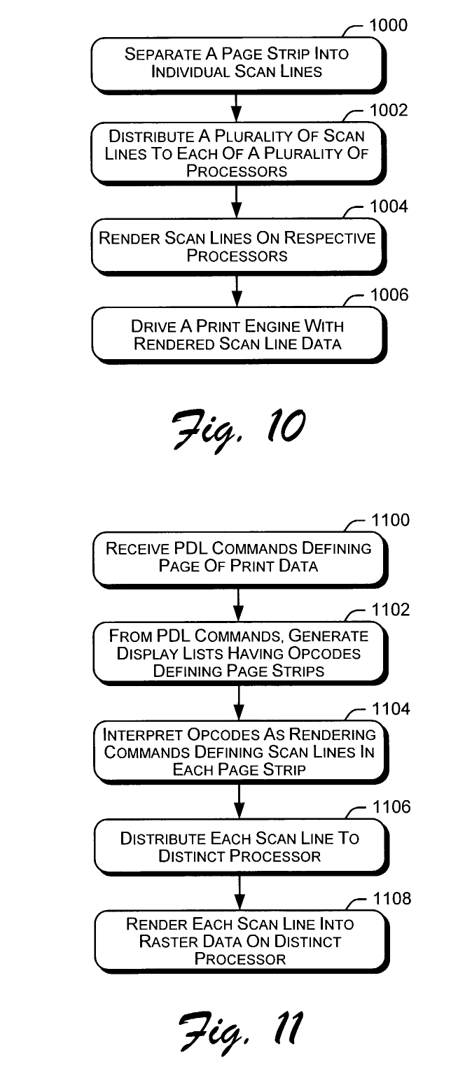

Referring now to the method illustrated in FIG. 10, at block 1000, a page strip is separated into individual scan lines. At block 1002, a plurality of scan lines is distributed to each of a plurality of processors. This typically occurs when there are more scan lines in each page strip than there are processors available for rendering the scan lines. Scan lines may be temporarily stored in a local memory on each processor, or they may be temporarily stored in a shared memory that is accessible by each processor, and then retrieved from the shared memory by each processor. At block 1004, scan lines are rendered on their respective processors. At block 1006, rendered data drives a print engine to produce an object image according to the data.

Referring now to the method illustrated in FIG. 11, at block 1100, PDL drawing commands defining a page of print data are received. At block 1102, display lists are generated from the PDL commands. Each display list includes opcodes that define objects that fall within a respective page strip. At block 1104, opcodes within a display list are interpreted as rendering commands that define each of the scan lines within a page strip. At block 1106, each of the scan lines (i.e., the rendering commands defining each of the scan lines) are distributed to a distinct processor. A block 1108, each scan line is rendered into raster/pixel data by its respective distinct processor.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

Additionally, while one or more methods have been disclosed by means of flow diagrams and text associated with the blocks of the flow diagrams, it is to be understood that the blocks do not necessarily have to be performed in the order in which they were presented, and that an alternative order may result in similar advantages.

1. A processor-readable medium comprising processor-executable instructions configured for:
separating a page into scan lines; and
distributing scan line commands representing the scan lines among a plurality of processors for rendering in parallel.

2. A processor-readable medium as recited in claim 1, wherein the page comprises one or more elements selected from the group comprising page strips and page tiles; and
the separating a page comprises separating a strip or tile into scan lines

3. A processor-readable medium as recited in claim 1, wherein the distributing comprises dispatching scan line commands representing each scan line to a distinct processor.

4. A processor-readable medium as recited in claim 3, wherein the dispatching includes temporarily storing scan line commands representing each scan line in a local memory of a distinct processor.

5. A processor-readable medium as recited in claim 3, comprising further processor-executable instructions configured for rendering scan line commands representing each scan line on a respective distinct processor.

6. A processor-readable medium as recited in claim 1, comprising further processor-executable instructions configured for driving a print engine with rendered scan line data to print the scan lines on a print medium.

7. A processor-readable medium as recited in claim 1, comprising further processor-executable instructions configured for:
temporarily storing rendered data; and
driving a print engine with the rendered data to print the scan lines on a print medium.

8. A processor-readable medium as recited in claim 7, wherein temporarily storing the rendered data includes compressing the rendered data, and driving the print engine with the rendered data includes decompressing the rendered data.

9. A processor-readable medium as recited in claim 1, wherein the scan lines outnumber the plurality of processors, the distributing comprising dispatching scan line commands representing a plurality of scan lines to each of the plurality of processors.

10. A processor-readable medium as recited in claim 1, wherein the distributing comprises:
queuing scan line commands representing each scan line into a main memory; and
for each of the plurality of processors, retrieving scan line commands representing a distinct scan line from the main memory and rendering the distinct scan line.

11. A processor-readable medium as recited in claim 1, wherein the page comprises a page strip defined by a display list having display list commands, the separating further comprising:
interpreting the display list commands; and
based on the interpreting, generating at least one scan line command to define each scan line.

12. A processor-readable medium as recited in claim 1, wherein the rendering in parallel comprises processing scan line commands on the plurality of processors to create pixel data.

13. A processor-readable medium as recited in claim 12, comprising further processor-executable instructions configured for driving a print engine with the pixel data.

14. A processor-readable medium comprising processor-executable instructions configured for:
dividing a page into separate scan lines;
initiating rendering commands for each scan line; and
assigning the rendering commands to a separate rendering processor.

15. A processor-readable medium as recited in claim 14, comprising further processor-executable instructions configured for executing each rendering command on its assigned rendering processor.

16. A processor-readable medium as recited in claim 14, wherein the scan lines outnumber the rendering processors, the assigning comprising assigning rendering commands representing a plurality of scan lines to each of a plurality of rendering processors.

17. A processor-readable medium as recited in claim 14, wherein the page comprises one or more elements selected from the group comprising page strips and page tiles; and
the dividing a page comprises separating a page strip or page tile into scan lines.

18. A processor-readable medium comprising processor-executable instructions configured for:
receiving PDL (page description language) drawing commands defining a page of print data;
generating display lists from the PDL drawing commands, each display list having opcodes (operating codes) defining a strip of the page;
parsing the opcodes into rendering commands defining individual scan lines within each strip of the page;
distributing each of the individual scan lines to distinct processors; and
rendering each of the individual scan lines into raster data on a distinct processor.

19. A processor-readable medium as recited in claim 18, comprising further processor-executable instructions configured for driving a print engine with the raster data.

20. A processor-readable medium as recited in claim 18, comprising further processor-executable instructions configured for:
compressing the raster data;
temporarily storing compressed raster data;
decompressing the compressed raster data; and
sending decompressed raster data to a print engine.

21. A method of line based parallel rendering comprising:
separating a page into scan lines; and
distributing scan line commands representing each of the scan lines among a plurality of processors for rendering in parallel.

22. A method as recited in claim 21, wherein the distributing comprises distributing scan line commands representing a plurality of scan lines to each of a plurality of processors.

23. A method of line based parallel rendering comprising:
dividing a page into separate scan lines;
initiating rendering commands for each scan line; and
assigning rendering commands representing distinct scan lines to a separate rendering processor.

24. A method of line based parallel rendering comprising:
dividing a page strip into separate scan lines;
initiating a rendering command for each scan line; and
assigning a plurality of rendering commands to each of a plurality of rendering processors.

25. A method of line based parallel rendering comprising:
receiving PDL (page description language) drawing commands defining a page of print data;
generating display lists from the PDL drawing commands, each display list having opcodes (operating codes) defining a strip of the page;
parsing the opcodes into rendering commands defining individual scan lines within each strip of the page;
distributing rendering commands representing each of the individual scan lines to different processors; and
rendering each of the individual scan lines into raster data on a distinct processor.

26. A printer comprising:
a plurality of parallel rendering processors;
a display list having opcodes defining objects that fall within a particular page strip;
a display list interpreter to interpret the opcodes as rendering commands that define individual scan lines; and
a task distribution module configured to distribute rendering commands representing individual scan lines to the parallel rendering processors.

27. A printer as recited in claim 26, further comprising a shared memory configured to receive rendering commands representing individual scan lines prior to their distribution to the parallel rendering processors.

28. A printer as recited in claim 26, further comprising a local memory associated with each rendering processor for receiving rendering commands representing individual scan lines.

29. A printer as recited in claim 26, further comprising:
PDL (page description language) commands defining a page; and
a PDL parser to parse the PDL commands into display lists, each display list associated with a page strip.

30. A computer comprising:
a plurality of parallel rendering processors;
a display list having opcodes defining objects that fall within a particular page strip;
a display list interpreter to interpret the opcodes as rendering commands defining individual scan lines;
a task distribution module configured to distribute rendering commands representing individual scan lines to the parallel rendering processors; and
a printer driver to send rendered scan line data to a printer.

31. A computer as recited in claim 30, further comprising a shared memory configured to receive rendering commands representing individual scan lines prior to their distribution to the parallel rendering processors.

32. A computer as recited in claim 30, further comprising a local memory associated with each rendering processor for receiving rendering commands representing individual scan lines.

33. A printer comprising:
means for separating a page into scan lines; and
means for distributing scan line commands representing the scan lines among a plurality of processors for rendering in parallel.

34. A printer comprising:
means for dividing a page into separate scan lines;
means for initiating rendering commands for each scan line; and
means for assigning the rendering commands to a separate rendering processor.

35. A printer comprising:
means for receiving PDL (page description language) drawing commands defining a page of print data;
means for generating display lists from the PDL drawing commands, each display list having opcodes (operating codes) defining a strip of the page;
means for interpreting the opcodes as rendering commands, the rendering commands defining individual scan lines within each strip of the page;
means for distributing each of the individual scan lines to a distinct processor; and
means for rendering each of the individual scan lines into raster data on a distinct processor.
